(19) United States
(12) Patent Application Publication
(10) Pub. No.: US 2016/0328989 A1
(43) Pub. Date: Nov. 10, 2016

(54) BOARD GAME AND ASSOCIATED AND METHODS

(71) Applicant: Jill S. Jicha, North East, MD (US)

(72) Inventor: Jill S. Jicha, North East, MD (US)

(21) Appl. No.: 15/099,001

(22) Filed: Apr. 14, 2016

Related U.S. Application Data
(60) Provisional application No. 62/157,012, filed on May 5, 2015.

(51) Int. Cl. G09B 19/00; G09B 3/02; A63F 3/04

(52) U.S. Cl. CPC G09B 19/00; A63F 3/04; G09B 3/02

(57) ABSTRACT

Exemplary embodiments are directed board games that include a board, a plurality of position markers disposed on the board, and a plurality of cards. The position markers can create a path leading from a starting point to a finish point. Some of the plurality of cards include at least one of issue questions or interview questions to be answered by a player. In some embodiments, the board games include a plurality of food cards, a portion of the food cards being distributed to the player. At least some of the plurality of cards can require the player to create a meal or snack with the food cards distributed to the player. Exemplary embodiments are also directed to methods of playing a game.

### CROSS-REFERENCE TO RELATED APPLICATION

This application claims the priority benefit of U.S. Provisional Application Ser. No. 62/157,012 filed May 5, 2015, which is hereby incorporated by reference in its entirety.

### TECHNICAL FIELD

The present disclosure relates to board games and associated methods and, in particular, to board games for teaching pre-employment skills to employment seekers.

### BACKGROUND

Seeking employment can be a tedious and drawn-out process. A major portion of seeking employment involves a search for job openings for which a person can apply. However, in addition to the process of searching for employment, employment seekers also need to spend time preparing for interviews and improving their employment skills to increase the chances of finding employment. The process of preparing for interviews and improving employment skills can add to the stress normally involved during the employment seeking process.

Traditional board games exist for a number of various uses. For example, board games can be solely for fun, require some form of strategy, or can be used for educational purposes. However, traditional board games generally do not assist employment seekers with preparing for interviews and improving employment skills.

Thus, a need exists for board games that teach pre-employment skills to employment seekers These and other needs are addressed by the board games and associated methods of the present disclosure.

### SUMMARY

In accordance with embodiments of the present disclosure, exemplary board games are provided that include a board, a plurality of position markers disposed on the board, and a plurality of cards. The position markers can create a path leading from a starting point to a finish point. One feature of the invention is that some of the plurality of cards can include an interview card that provides an interview question to be answered by a player. Another feature of the invention is that some of the plurality of cards can include an issue card that provides an issue question to be answered by a player. Another feature of the invention is that the board games can include a plurality of food cards, a portion of the plurality of food cards being distributed to the player and used at predetermined points during the game.

Another feature of the invention is that the board game can be played using only interview cards. Another feature of the invention is that the board game can be played using only issue cards. Another feature of the invention is that the board game can be played using only food cards. Another feature of the invention is that the board game can be played using interview and issue cards. Another feature of the invention is that the board game can be played using a combination of interview cards, issue cards, food cards, or the like.

One feature of the invention includes a board, having a plurality of position markers disposed thereon. The position markers can create a path leading from a starting point to a finish point. Another feature of the invention is that symbols can be disposed on each of the position markers. The symbols can be at least one of a first symbol, a second symbol, or a token symbol. The first symbol can correspond to issue cards of the plurality of cards. The issue cards can include the issue questions relating to problem solving. The second symbol can correspond to interview cards of the plurality of cards. The interview cards can include the interview questions relating to interviews.

Another feature of the invention is that the board games can include tokens. The tokens can be collected by the player upon correctly answering questions of the plurality of cards. In certain embodiments, a player must collect a predetermined number of tokens to move into the finish point.

The board games can further include a shortcut path formed by some of the position markers. The shortcut path can decrease the steps along the path between the starting point and the finish point.

An alternative feature of the invention includes a method wherein a player piece is moved along the position markers of the path. The method can include selecting at least one of an issue card or an interview card from the plurality of cards, the issue card including the issue question and the interview card including the interview question. The methods further include answering at least one of the issue question or the interview question and granting the player the right to move to the next position marker.

Another feature of the invention is that a portion of the plurality of food cards can be distributed to a player. At least one of the plurality of cards can require the player to create a meal or snack with at least some of the food cards distributed to the player. In some embodiments, the meal or snack can be a healthy meal or snack. Each of the plurality of food cards can include a food item illustration thereon.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed board games and associated methods, reference is made to the accompanying figures, wherein:

FIG. 1 is a top, perspective view of an exemplary board game according to the present disclosure;

FIG. 2 is a detailed, top view of an exemplary board game of FIG. 1;

FIG. 3 is a detailed, top view of an exemplary board game of FIG. 1;

FIG. 4 is a detailed, top view of components of an exemplary board game of FIG. 1;

FIG. 5 is a detailed, top view of components of an exemplary board game of FIG. 1;

FIG. 6 is a top view of exemplary cards of a board game of FIG. 1; and

FIG. 7 is a top view of exemplary cards of a board game of FIG. 1.

### DESCRIPTION OF EXEMPLARY EMBODIMENTS

In accordance with embodiments of the present disclosure, exemplary board games are provided for teaching pre-employment skills to employment seekers. The board games provide a substantially stress-free means of learning pre-employment skills during an already stressful time of seeking employment. The board game can be used to teach pre-employment skills to a variety of people, e.g., students, people with disabilities, unemployed adults, or the like. The board game can also be used by players to maintain a level of skills even during employment.

The board game can be used to educate people about appropriate work behaviors and encourages the development of soft skills to enhance communication and positive interactions in the workplace. The board game can assist people in a variety of ways depending on a person's background. For example, if a person has not been exposed to role models with a good work history, the person may not be aware of appropriate workplace behaviors and/or work culture expectations due to limited or no experience functioning in the employment sector. As a further example, players can be young and/or immature and just now coming of age where the players are thinking about work or career for the first time. As such, the board game can introduce such people to appropriate workplace interactions and behaviors.

The exemplary board games include a board, a plurality of position markers disposed on the board, and a plurality of cards (e.g., decks of cards). The position markers can create a path leading from a starting point to a finish point. All player pieces can start at the starting point and move along the position markers of the path to earn tokens and reach the finish point. As the players move along the path and land on the position markers, symbols on the position markers can dictate which card the player should select from the plurality of cards. The plurality of cards can include an interview question, an issue question, or the like, to be answered by a player.

In some embodiments, the board games include a plurality of food cards. A portion of the plurality of food cards can be distributed to the player before commencing playing of the game. Selecting an issue card with a meal illustration (e.g., a meal card) requires the player to create a healthy lunch or snack with the food cards. A portion of the issue cards can include a mermaid/merman illustration thereon that provide information and/or questions relating to inappropriate work relationships.

Symbols can be disposed on each of the position markers. The symbols can be at least one of a first symbol, a second symbol, or a token symbol. The first symbol can correspond to issue cards of the plurality of cards. The issue cards can include questions relating to problem solving. The second symbol can correspond to interview cards of the plurality of cards. The interview cards can include questions relating to interviews. In particular, the interview questions can be employment interview questions that would typically be asked during an employment interview. In some embodiments, the issue cards can include inappropriate work relationship cards mixed therewith. The token symbol can correspond to automatic collection of a token by the player.

The board games can include player pieces for moving along the path. The board games can include tokens. The tokens can be collected by the player upon correctly answering questions of the plurality of cards and/or landing on the token symbol. A player must collect a predetermined number of tokens to move into the finish point and win the game. In some embodiments, the board games can include a shortcut path formed by some of the position markers. The shortcut path can decrease the steps along the path between the starting point and the finish point. In some embodiments, some questions can be provided to the player in an audio or video format.

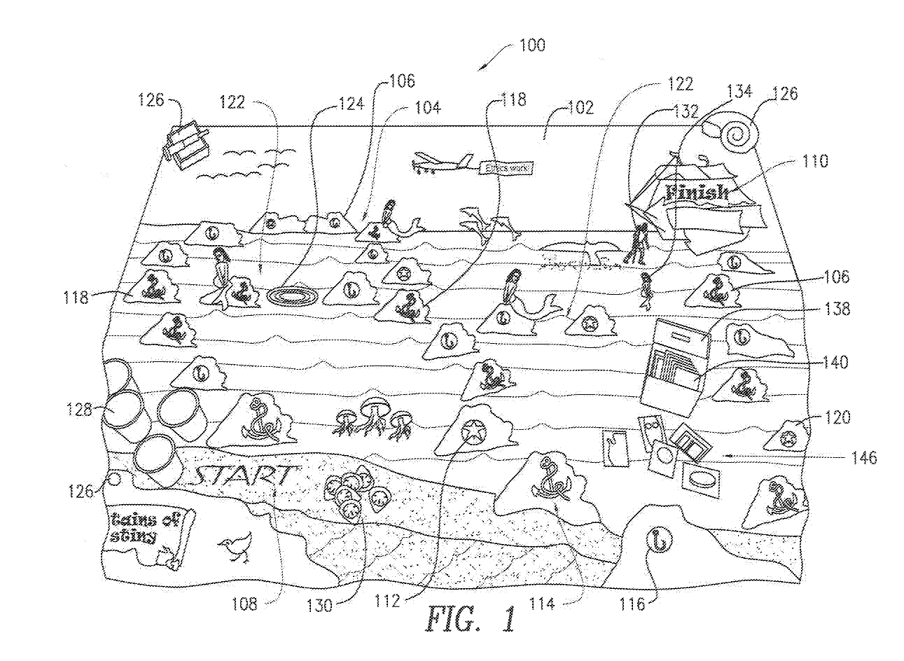

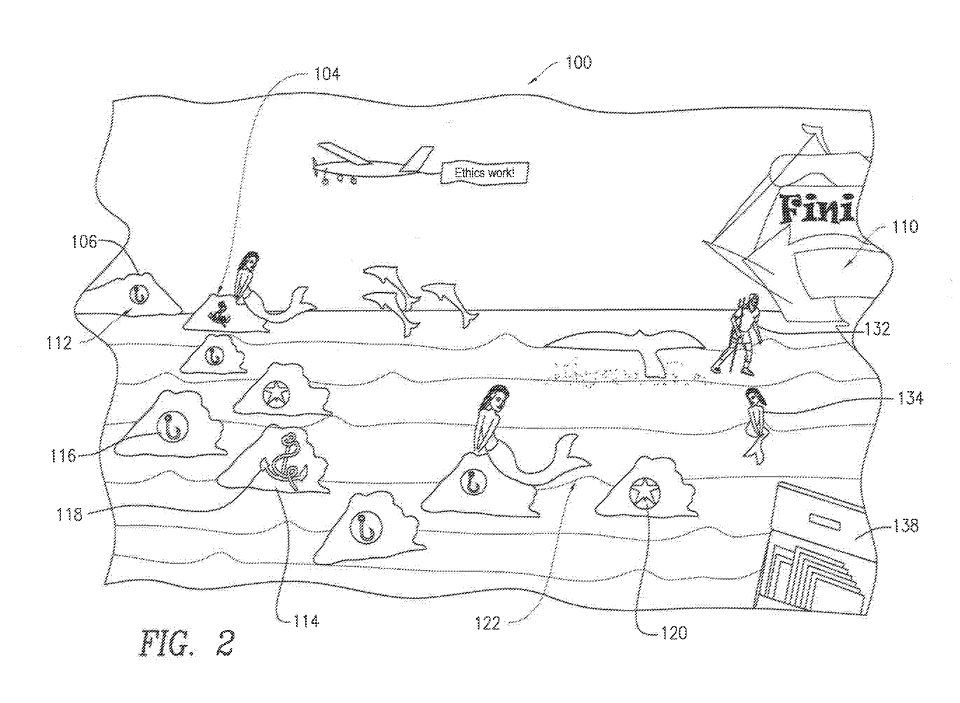

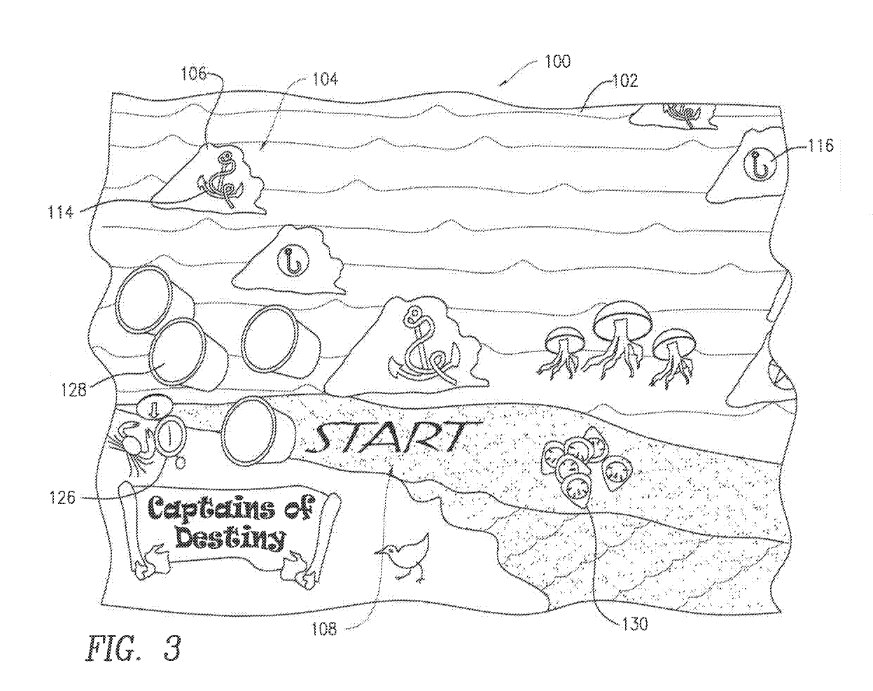

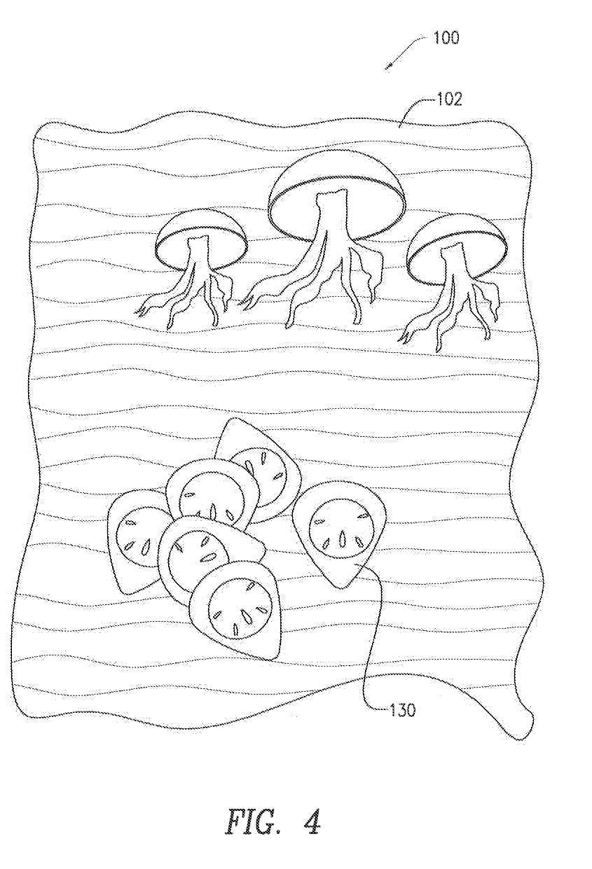

With reference to FIGS. 1-5, perspective and detailed views of an exemplary board game 100 and components of the board game 100 are provided. Although illustrated as a physical board game 100, in some embodiments, the board game 100 and the related components can be configured in an electronic format accessible via a computer including a processing device and a graphical user interface. For example, the board game 100 can be programmatically stored in a database accessible by the processing device, thereby allowing a player to participate in the board game 100 via a graphical user interface on a computer.

With respect to the embodiment illustrated in FIGS. 1-5, the board game 100 includes a board 102 on which the game can be played. In some embodiments, the board 102 can define a substantially rectangular configuration. In some embodiments, the board 102 can be fabricated from a flexible material such that the board 102 can be rolled or folded during non-use. Although illustrated as having a nautical theme with the name CAPTAINS OF DESTINY™ and nautical-themed illustrations, it should be understood that the board game 100 can be of a variety of themes.

### Path and Symbols

The components of the board 102 discussed herein can be printed on the board 102. The board 102 includes a path 104 along which players can move during the game. The path 104 includes a plurality of position markers 106 (e.g., stepping stones) separated by water, each position marker 106 corresponding to one more or step of the player. In the nautical-themed embodiment, the position markers 106 can be illustrated as boulders protruding from the water. The path 104 can begin at a starting point 108 and ends at a finish point 110. The starting point 108 can be positioned near the left, bottom corner of the board 102 and can be illustrated as a point near or on the sand of a beach. The finish point 110 can be illustrated as a ship in the water and away from the beach. The position markers 106 of the path 104 can lead a player from the starting point 108 on the beach to the finish point 110 on the ship.

Each position markers 106 can include a symbol 112 disposed thereon. The symbols 112 can include a first symbol 114 (e.g., an anchor), a second symbol 116 (e.g., a hook), and a token symbol 120 (e.g., a sand dollar). In some embodiments, the symbols 112 can be randomly distributed along the position markers 106 such that no similar symbols 112 are positioned on adjacent position markers 106. In some embodiments, the symbols 112 can be randomly distributed along the position markers 106 such that some similar symbols 112 can be positioned on adjacent position markers 106. In some embodiments, the symbols 112 can be strategically distributed along the position markers 106 such that certain paths (e.g., shortcuts 122) may be more difficult than other paths.

Although the position markers 106 can define the major path 104 across the board 102. In some embodiments, the path 104 can include one or more shortcuts 122 between the position markers 106. The shortcuts 122 can reduce the number of position markers 106 between certain points along the path 104. If passing next to the shortcut 122, the players involved in the game can choose whether to move along the main path 104 or take a shortcut 122. For example, if a player is at a position marker 118 immediately adjacent to or beside the shortcut 122 path after the previous turn, upon rolling the die to make the next move, the player can decide whether to move along the normal path 104 or to take the shortcut 122. In some embodiments, the player must be at the position marker 118 immediately adjacent to or beside the shortcut 122 path before rolling the die in order to have the option of taking the shortcut 122. In some embodiments, the player must be at a position marker 106 before the shortcut 122 path before rolling the die in order to have the option of taking the shortcut 122 if the appropriate number is rolled with the die.

Although the shortcuts 122 provide a shorter route along the path 104, the shortcuts 122 can include position markers 106 and/or penalty positions 124 (e.g., a whirlpool symbol) that can make taking the shortcut 122 a riskier endeavor than continuing along the main path 104. For example, in some embodiments, landing on the penalty position 124 can automatically force the player to move back to the starting point 108. In some embodiments, if a player lands on the penalty position 124, the player can roll the dice again to determine if a penalty will be incurred by the player. For example, if the player lands on the penalty position 124 and rolls an odd number with the dice, the player can be safe on the penalty position 124 and does not need to move back to the starting point 108. As a further example, if the player lands on penalty position 124 and rolls an even number with the dice, the player can be forced to move back to the starting point 108. The player therefore is required to decide whether to risk taking the shortcut 122 or proceed along the main path 104.

### Player Pieces and Tokens

In addition to the illustrations on the board 102, the board game 100 can include a plurality of components for participating in the game. In some embodiments, the board game 100 can include player pieces 126 that each respective player can use to move along the path 104. The player pieces 126 can be configured as general blocks or can represent configurations specific to the theme of the game, e.g., a chest, a marine telescope, a shell, a compass, or the like.

The board game 100 can include player pieces 128 in the form of buckets, sand pails or containers. The player pieces 128 can be configured and dimensioned to receive therein components of the game, e.g., tokens, cards, or the like. In some embodiments, each player can be assigned a player piece 126 and a player piece 128. The player piece 126 can be used to move along the path 104 and the player piece 128 can be kept with the player to hold the received components associated with the game. In some embodiments, each player can be assigned only a player piece 128. The player piece 128 can therefore be used to move along the path 104 and to hold the received components associated with the game. The player pieces 128 can be of different colors to allow the players to distinguish their player piece 128 from the others.

The board game 100 can include a plurality of tokens 130 for collection by the players. In some embodiments, the tokens 130 can be hot-stamped on plastic. The tokens 130 can include an illustration printed thereon that corresponds to the token symbol 120 on the position markers 106, e.g., a sand dollar. If the player lands on a position marker 106 having the token symbol 120 and/or if the player answers certain questions correctly, the player can be awarded a token 130. The collected tokens 130 can be stored in the respective player piece 128. In some embodiments, to win the game, the player must receive a certain number of tokens 130 in order to “board” the ship at the finish point 110. For example, the player must receive fifteen tokens 130 to “board” the ship at the finish point 110 and win the game. If the player has not collected fifteen tokens 130 upon reaching the finish point 110, the player can be required to continue moving along the path 104 until the necessary amount of tokens 130 have been collected to “board” the ship at the finish point 110.

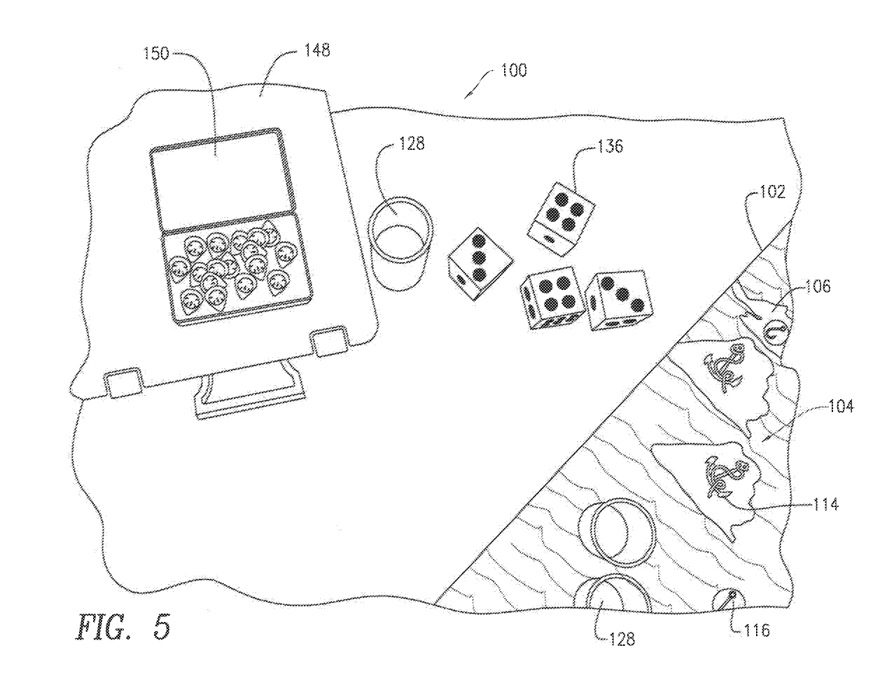

The board game 100 can include one or more dice 136 (see, e.g., FIG. 5). In some embodiments, the board game 100 can include multiple dice 136 of different colors. Each player can be assigned a specific color dice 136 and can use the same dice 136 throughout the game. For example, the color of the dice 136 can correspond to the color of the player piece 128 assigned to the player. In some embodiments, the board game 100 can include only a single dice 136 and each player uses the same dice 136. The dice 136 can be used by the players to determine how many position markers 106 the player is allowed to move along the path 104. During their turn, each player can be permitted to roll one dice 136, resulting in a number between one and six. In some embodiments, each player can be permitted to roll two dice 136 to determine the number of steps to take. Based on this number, the player can move along the path 104 to the corresponding position marker 106. Based on the illustration on the position marker 106, the player may be required to perform a certain action.

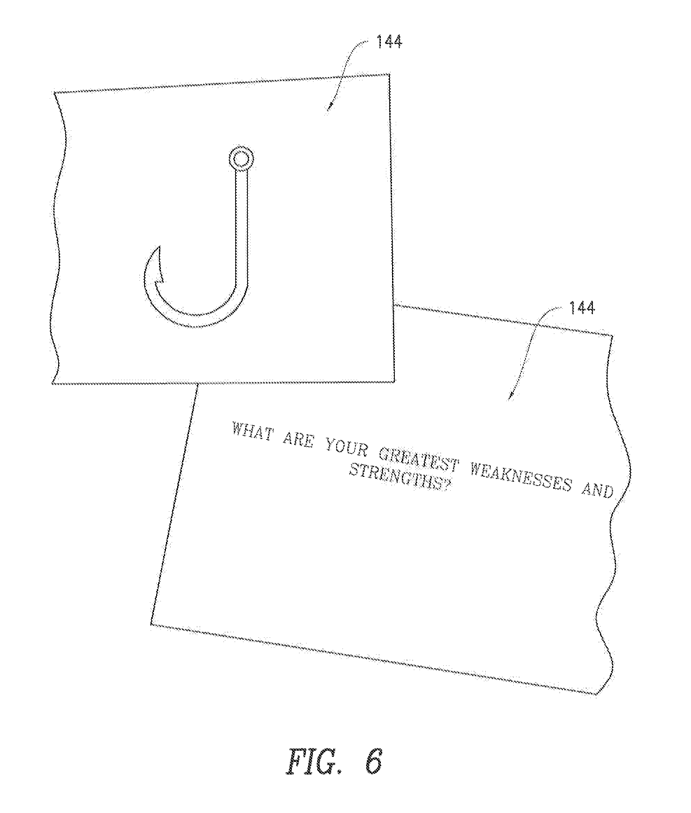

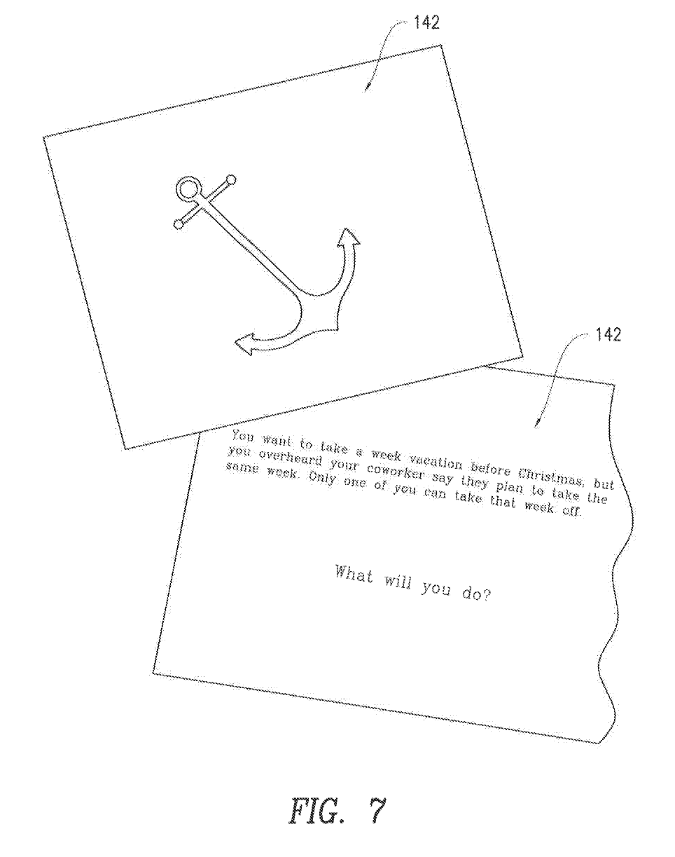

In some embodiments, the board game 100 can include a container 138, e.g., a treasure chest, configured and dimensioned to hold a plurality of cards 140. In some embodiments, the cards 140 can be placed on the surface of the board 102 instead of being kept in the container 138 and can be positioned in the container 138 after use. The cards 140 can include two or more decks of cards relating to, e.g., issue cards 142, interview cards 144, or the like (see, e.g., FIGS. 6 and 7). One side of each card 140 can include an illustration corresponding to a symbol 112 on the board 102.

Thus, for example, each separate deck of cards 140 can be individually placed on the board 102. Upon landing on the corresponding symbol 112 on the position markers 106, the player can be required to take a card 140 and perform the task or answer the question indicated on the card 140. For example, the first symbol 114 (e.g., an anchor) can correspond to the anchor symbol on the issue cards 142, and the second symbol 116 (e.g., a hook) can correspond to the hook symbol on the interview cards 144. In some embodiments, the board game 100 can be played with, e.g., both the issue cards 142 and the interview cards 144, the issue cards 142 without the interview cards 144, the interview cards 144 without the issue cards 142, or the like.

### Interview Cards

The interview cards 144 can include a symbol or illustration (e.g., a hook) on one side corresponding to the second symbol 116, and include a question on an opposing side to be answered by the player (see, e.g., Examples A-K in “Examples” section). The topic of the questions on the interview cards 144 (e.g., hook cards) can relate to questions typically encountered during an interview. The hook symbol can correspond to a person being “on the hook” during an interview when a question is asked. In particular, the interview cards 144 can require a player to think about and answer questions relating to job interviews. Young people need to be prepared to respond successfully to questions posed by the interviewer or company representative during an interview. Interview questions help the interview or company representative discern whether the job candidate is a good fit for the position. The interview questions 144 are intended to help the perspective job seeker to think about what the employer wants and how the job seeker might fit in the specific employment environment. For example, the questions can relate to information about the applicant's background, experience, weaknesses, strengths, goals, future plans, work environment, interest in a company, desired salary, whether the applicant is a team player, or the like.

In some embodiments, the board game 100 can include a separate answer sheet including answers to the questions of the interview cards 144. In some embodiments, the answers to the questions of the interview cards 144 can be printed upside down on the same side as the question. In some embodiments, the questions can be written such that the answer can be in a sentence, phrase or narrative format. In some embodiments, the questions can be multiple choice such that only one answer is considered correct. In some embodiments, the questions can be more open-ended, pushing the player to deeply consider certain topics that could be discussed at an interview. The answer provided by a player to an open-ended question can be graded by a consensus of all players participating in the game. In particular, the open-ended questions can have the goal of generating conversations about a particular interview question resulting in a mutual conclusion of all players involved. In some embodiments, rather than being in a written format, the questions on the interview cards 144 can refer to a corresponding CD or DVD accessible via a computer, a CD player, a DVD player, or the like, that includes audio or video questions to be answered. In some embodiments, the audio or video question can be accessed on a website via a computer. In some embodiments, a projector can be used to project the video questions on a wall. If the player answers the question correctly, a token 130 is earned by the player. If the player does not answer the question correctly, a token 130 is not earned and the player can await the next turn.

### Issue Cards

The issue cards 142 can include a symbol or illustration (e.g., an anchor) on one side corresponding to the first symbol 114, and include a question on an opposing side to be answered by the player (see, e.g., Examples L-V in “Examples” section). The questions of the issue cards 142 can help illuminate challenges to employment by posing questions about real life situations. During the game, as players select the issue cards 142 that pose these questions, job seekers can begin to develop strategies for coping with life and work. In some embodiments, the topic of the questions on the issue cards 142 (e.g., anchor cards) can relate to issues that can weigh a person down in life, problem solving topics, or life skill topics. For example, the questions can relate to difficult decisions that must be made in the workplace regarding the work environment, interactions with other employees, interactions with upper management, security issues, work ethics, or the like.

In some embodiments, the board game 100 can include a separate answer sheet including answers to the questions of the issue cards 142. In some embodiments, the answers to the questions of the issue cards 142 can be printed upside down on the same side as the question. In some embodiments, the questions can be written such that the answer can be in a sentence, phrase or narrative format. In some embodiments, the questions can be multiple choice such that only one answer is considered correct. For example, with the question shown in FIG. 7, four or five answer choices can be provided to the player to choose from. In some embodiments, rather than being in a written format, the questions on the issue cards 142 can refer to a corresponding compact disc (CD) or digital versatile disc (DVD) accessible via a computer, a CD player, a DVD player, or the like, that includes audio or video questions to be answered. In some embodiments, the audio or video question can be accessed on a website via a computer. In some embodiments, a projector can be used to project the video questions on a wall. If the player answers the question correctly, a token 130 is earned by the player. If the player does not answer the question correctly, a token 130 is not earned and the player can await the next turn.

### Food Cards

The board game 100 can include a plurality of food cards 146. The food cards 146 can include images thereon of a variety of foods, e.g., healthy foods, junk foods, or the like. For example, the food cards 146 can include images and names of fruits, vegetables, chips, water, soft drinks, candy, or the like. For example, the food cards 146 can include images and names of healthy foods, such as bottle of water, salad, celery, carrots, cherry tomatoes, apple, orange, banana, quinoa, brown rice, or the like. As a further example, the food cards 146 can include images and names of unhealthy foods, such as a can of soda, an energy drink, flavored iced-tea drink, candy, bag of chips, hot dog, cookies, cupcakes, pork rinds, chewing gum, or the like. Prior to starting the game, each player can be assigned a certain number of food cards 146, e.g., five cards, six cards, seven cards, or the like.

In some embodiments, one or more meal cards (e.g., including an illustration of a brown paper sack or a treasure chest) can be randomly mixed into the deck of issue cards 142. In some embodiments, the deck of issue cards 142 can include issue cards 142 that, rather than a question, include an illustration of a brown paper sack or a treasure chest, thereby indicating a meal card. If a player lands on the first symbol 114 and is required to select an issue card 142, the next card in the deck of issue cards 142 may be the meal card. As such, rather than an issue card 142, the player would be required to take the meal card. The meal card can require the player to make a healthy lunch or snack with the food cards 146. In some embodiments, the player can be limited to a predetermined time to create the healthy lunch or snack, e.g., thirty seconds, one minute, two minutes, or the like. In some embodiments, the player can have one minute to pack the healthy lunch or snack. In some embodiments, the board game 100 can include a one minute timer (e.g., an electronic timer, an hourglass, or the like) for timing the lunch or snack packing.

In some embodiments, the board game 100 can include an answer sheet related to the food cards 146 that includes a food pyramid or visual for matching of the food cards 146 selected by the player. For example, the food cards 146 can be color-coded such that the selected food cards 146 for the snack can be compared to the answer sheet to determine if the lunch or snack is healthy. In some embodiments, the healthiness of the lunch or snack can be determined based on the type of foods selected by the player. For example, the lunch or snack can still be considered healthy if only one unhealthy food is used. If the player has created a healthy lunch or snack, the player earns one token 130. If the player creates an unhealthy snack, the player does not earn the token 130 and can await the next turn.

### Merman/Mermaid Cards

In some embodiments, the board game 100 can include one or more figures 132, 134, e.g., a merman figure and a mermaid figure, respectively. One or more merman/mermaid cards including a merman/mermaid illustration thereon can be randomly mixed with the deck of issue cards 142. In some embodiments, the deck of issue cards 142 can include issue cards 142 that, rather than a question, include an illustration of a merman/mermaid, thereby indicating a merman/mermaid card. If a player lands on the first symbol 114 and is required to select an issue card 142, the next card in the deck of issue cards 142 may be the merman/mermaid card. As such, rather than an issue card 142, the player would be required to take the merman/mermaid card. If a female player takes the merman/mermaid card, the female player would be required to place a corresponding mermaid figure 134 into their player piece 128 and would lose a turn. Similarly, a male player would be required to place a corresponding merman figure 132 into their player piece 128 and would lose a turn. The figure 132, 134 in the player piece 128 can indicate that the player is losing a turn. The player can remove the figure 132, 134 from their player piece 128 at the next turn and can continue to play. The player thereby loses the chance to earn a token 130.

In some embodiments, the merman/mermaid cards can include information regarding inappropriate work relationships. For example, the merman/mermaid cards can describe what scenarios would be considered inappropriate work relationships in a typical business setting. In some embodiments, the merman/mermaid cards can include a written question relating to inappropriate work relationships to be answered by the player. For example, if the player answers the question on the merman/mermaid card correctly, the player will not lose a turn. However, if the player incorrectly answers the question on the merman/mermaid card, the player will lose a turn as described above.

Landing on a position marker 106 with a token symbol 120 allows the player to earn a token 130 without having to answer a question or perform a task. In some embodiments, the board game 100 can include a container 148 for storing the various components of the board game 100, e.g., the cards 140, figures 132, 134, player pieces 126, 128, food cards 146, the container 138, the dice 136, the tokens 130, the answer sheets, or the like. In some embodiments, the board game 100 can include a container 150 for separately storing the tokens 130. In some embodiments, the container 148 can be dimensioned to receive therein the board 102 in a folded or rolled configuration.

### Playing the Game

To play the board game 100, the players can initially roll their dice 136 to determine who moves first. For example, the player with the highest number can be the first player to move. One player moves at each point of the game. The players can roll their dice 136 and, based on the rolled number, can move their player pieces 126 (or player pieces 128) along the position markers 106. Based on the symbol 112 on the position marker 106, the players can select the appropriate card and answer questions/challenges or perform tasks. If the player answers the questions correctly or performs the task properly, the player collects a token 130 in their player piece 128. If the player answers the question incorrectly or performs the task improperly, the player does not earn a token 130 and stays on their spot until the next round when the player can roll the dice 136 and move forward again to land on a new position marker 106.

The players thereby move along the path 104 from the starting point 108 to the finish point 110. To win the game (e.g., “board” the ship), the player must reach the finish point with a predetermined number of collected tokens 130 (e.g., ten tokens, fifteen tokens, twenty tokens, or the like). If the player has managed to move along the path 104 (or shortcuts 122) to arrive at the finish point 110 without collecting the necessary number of tokens 130, the player is required to work their way around the board 102 to earn more tokens 130. Upon collecting the required number of tokens 130, the player can continue moving along the path 104 to reach the finish point 110. The board game 100 thereby provides a means of learning pre-employment skills in a stress-free and gaming environment. Additional examples of playing the board game 100 are provided below (see, e.g., Examples W-FF in the “Examples” section).

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

### EXAMPLES

### Examples 1-11

### Interview Questions

To assist those of skill in the art in making and using the disclosed board games and associated methods, reference is made to the below non-limiting Examples 1-11 of interview questions

### Example 1

“What are your greatest weaknesses and strengths?” (see, e.g., FIG. 6).

### Example 2

“How many hours of overtime are you willing to work on a routine basis? a) 0 hours per week; b) 2 hours per week; c) 4 hours per week; d) As many hours as are needed to get the job done.”

### Example 3

“If you noticed a coworker open a package of candy, take several pieces, then put the open bag back on the self and go back to work you would: a) Ignore the issue, it is none of your business; b) Talk to the coworker, let him know you saw him take the candy, joke about how the company has lots of money so a few pieces of candy won't hurt anything; c) Tell your supervisor and let her handle the situation, but request they keep your name confidential when dealing with your coworker.”

### Example 4

“Why do you want to work for this company? a) I need the money, I am saving for a car; b) Your company is known for making great products that help people and I want to be part of that business model; c) I can save gas money since it is close to my house; d) Working here will allow me to use my current skills and develop new ones; e) This company is one of the better places to work in this town.”

### Example 5

“Why did you leave your last job? a) The manager at my last job was mean to me so I was not comfortable staying there; b) They changed my hours and I did not want to work nights; c) It was a temporary job. I worked hard and learned a lot. I am ready to use what I learned there to be even more successful at my next job; d) They did not pay me enough to stay.”

### Example 6

“What salary range are you looking for? a) Whatever you want to pay me, it is all about the “Benjamins”; b) What is the starting pay for this position?; c) It does not really matter as long as I have a job.”

### Example 7

“Tell me about your strengths. a) Some of my strengths include “follow through” and meeting deadlines; b) My real strength is attention to detail; c) One of my strengths is I am a good listener, people are always telling me their secrets because they think I can be trusted; d) One strength of mine is a willingness to stay late, since I am not a “morning person”.”

### Example 8

“What kind of training do you have for this job? a) I took a course in (name of program) and received by certificate of completion; b) No real training, but I am a fast learner; besides, this is not “rocket science”, right?; c) I do not have formal training, but I do have several years of experience doing this type of work.”

### Example 9

“What do you do in your spare time? a) I volunteer at our local library/animal shelter/Boys and Girls Club/4-H Club, etc.; b) I am a gamer, I can play for hours at a time, I am in a fantasy league and sometimes we play all night; c) I like to relax by reading/going to the movies/spending time with family/friends; d) I hunt and fish; e) All my free time is spent at church.”

### Example 10

“Have you ever quit or been terminated from a job? a) I was terminated for poor job performance, but I learned a lot from that experience; b) I quit my last job because they hired a new manager and he did not like me; c) I would not say I was “terminated”, more like laid off because there was not enough work; d) I left my previous job because I wanted to find a more challenging job.”

### Example 11

“How many sick days have you taken in the past year? a) None; b) I was off for a week with the flu; c) I only take off sometimes when I get bad migraines; d) I was off for 6 weeks after I tripped over a box someone left near my desk and dislocated my shoulder.”

### Examples 12-22

### Issue Questions

To assist those of skill in the art in making and using the disclosed board games and associated methods, reference is made to the below non-limiting Examples 12-22 of issue questions.

### Example 12

“You want to take a week vacation before Christmas, but you overheard your coworker say they plan to take the same week. Only one of you can take that week off. What will you do?” (see, e.g., FIG. 7).

### Example 13

“Which of the following is a good reason to call out sick from work? a) You wake up with a headache; b) you have a cold or flu with fever and bowel issues; c) You have a toothache; d) Your family is coming to visit and you need to clean your house/apartment; e) You just don't feel like going to work, you need a mental health day.”

### Example 14

“You are attracted to your coworker and want to ask him/her out so you: a) Wait and ask them for their phone number at lunch or break time; b) Watch them arrive for work in the morning then put a note on their car with your phone number and a message asking them to call you; c) Remain professional because it is not a good idea to date people you work with.”

### Example 15

“A coworker has been consistently rude to you and you have no idea why. Today you noticed him talking with another coworker across the room, he pointed at you and they both laughed so you: a) Ignore then and focus on your work; b) Feel sad he is so mean to you and start crying; c) Stop working and go tell your supervisor; d) Talk to your supervisor after work and let her know how your coworker is acting towards you.”

### Example 16

“You ride public transportation to get to work. You had a long day, you are hungry and tired. You used your last ticket to take the bus home and you will need a new ticket to get to work tomorrow. When you get off the bus at your stop you: a) Go home, you can worry about getting a bus ticket tomorrow morning on your way to work; b) Notice there is a line at the ticket counter and think “who cares about a stupid bus ticket?”; c) Wait in line patiently and buy a new bus ticket before going home; you don't want to take the chance of being late to work if there is a line at the ticket window tomorrow morning; d) Go home and ask your parents if they will drive you to work because you're all out of bus tickets.”

### Example 17

“You forgot your identification (ID) badge at home and you need it to get into the building so you: a) See a coworker walk into the building and ask him to swipe his badge to let you in so you will not be late, even though it is against company policy; b) Go to the security desk and ask to sign in/explain that you forgot your badge; c) Make up a story about how you think a coworker stole your badge so they will not think you are dumb for forgetting your badge at home.”

### Example 18

“It is almost lunch time and you just remembered you left your lunch on the bus and your wallet on the dresser at home so you: a) Ask a coworker if you can borrow money to get lunch from the vending machine and promise to pay them back; b) Sneak down to the lunch room early and take a little food from other people's lunches so you have enough to eat; c) Call a family member/friend and ask them to bring you lunch; d) Deal with it by drinking water from the water cooler and the free coffee/tea your company provides in the lunch room.”

### Example 19

“Your boss asks you to hand in a completed report by 11:00 am Monday. It is Sunday night and you have not started the report yet so you: a) Decide to call out sick Monday to give yourself more time to write the report; b) Go to work and tell your boss you emailed the report from your home computer Sunday night. When he says he did not receive it, tell him you will check when you get home, then go home and write the report Monday night—after all, why should you give up your weekend to write a stupid report? c) Set aside quiet time over the weekend to finish the report.”

### Example 20

“Which of the following email addresses are appropriate for work: a) cheesehead1991@gmail.com; b) bigjohn24@aol.com; c) sexychocolategrl@google.com; d) smith.karen@verizon.com.”

### Example 21

“You have been working for three months and love your job, but you could really use a raise because you are not earning enough to pay your bills so you: a) Go talk to your boss, tell him what a good job you are doing and ask for a raise; b) Explain to your boss that you are not making enough money and if he does not give you a raise, you will have to look for another job; c) Review your spending habits, put yourself on a budget and learn to live within your means; d) Quit and look for another job that pays more.”

### Example 22

“A coworker has borrowed money from you and has not paid you back so you: a) Leave a note on their desk that says “You owe me $5”; b) You see them in the hall and say “Hey, do you have that $5 you owe me?”; c) You go to the human Resource office and file a complaint; d) You forget about it, you don't want to cause a problem at work.”

One Example of Several Turns of Game Played with 4 Players.

All players can place their player pieces 128 near the word START at the starting point 108. Each player can select seven laminated food cards 146. The laminated food cards 146 can be stored in the respective player pieces 128 during the game until use of the food cards 146 is necessary. Each player can roll their respective dice 136. The player with the highest number on their dice 136 can go first. The player to the right of the player to go first can be second, and so forth.

Player 1 rolls their dice 136 and rolls the number four. Player 1 moves the appropriate player piece 128 four spaces (e.g., four position markers 106) from the starting point 108 and lands on a first symbol 114 (e.g., an anchor symbol) corresponding to the issue cards 142. Player 1 therefore takes the top card from the issue card 142 deck. Player 1 reads the selected issue card 142 out loud. The issue card 142 reads: “A coworker has been consistently rude to you and you have no idea why. Today you noticed him talking with another coworker across the room, he pointed at you and they both laughed so you: a) Ignore then and focus on your work; b) Feel sad he is so mean to you and start crying; c) Stop working and go tell your supervisor; d) Talk to your supervisor after work and let her know how your coworker is acting towards you.” Player 1 chooses answer C. This is not the correct answer (the correct answer is A). Player 1 therefore does not earn a sand dollar token 130 and remains at the same position marker 106 on which Player 1 had landed. Player 1 places the selected issue card 142 in a used card deck or at the bottom of the issue card 142 deck. Player 1's turn is now over.

Player 2 rolls their dice 136 and rolls the number two. Player 2 moves the appropriate player piece 128 two spaces (e.g., two position markers 106) from the starting point 108 and lands on a second symbol 116 (e.g., a hook symbol) corresponding to the interview cards 144. Player 2 therefore takes the top card from the interview card 144 deck. Player 2 reads the selected interview card 144 out loud. The interview card 144 reads: “Why do you want to work for this company? a) I need the money, I am saving for a car; b) Your company is known for making great products that help people and I want to be part of that business model; c) I can save gas money since it is close to my house; d) Working here will allow me to use my current skills and develop new ones; e) This company is one of the better places to work in this town.” Player 2 chooses answer B. This is the correct answer (while answer D is also an acceptable answer). Due to the correct answer, Player 2 earns a sand dollar token 130 and places the sand dollar token 130 in the player piece 128. Player 2 places the selected interview card 144 in a used card deck or at the bottom of the interview card 144 deck. Player 2's turn is now over.

Player 3 rolls their dice 136 and rolls the number six. Player 3 moves the appropriate player piece 128 six spaces (e.g., six position markers 106) from the starting point 108, chooses the shortcut 122 path, and lands on the penalty position 124. Player 3 rolls the dice 136 again to determine if a penalty will be incurred, requiring Player 3 to move back to the starting point 108. Player 3 rolls the number two. Since Player 3 rolled an even number, Player 3 incurs a penalty and must move the player piece 128 back to the starting point 108. If Player 3 had rolled an odd number, Player 3 could have stayed in the penalty position 124 without incurring a penalty. Player 3's turn is now over.

Player 4 rolls their dice 136 and rolls the number five. Player 4 moves the appropriate player piece 128 five spaces (e.g., five position markers 106) from the starting point 108 and lands on a second symbol 116 (e.g., a hook symbol) corresponding to the interview cards 144. Player 4 therefore takes the top card from the interview card 144 deck. Player 4 reads the selected interview card 144 out loud. The interview card 144 reads: “If you noticed a coworker open a package of candy, take several pieces, then put the open bag back on the self and go back to work you would: a) Ignore the issue, it is none of your business; b) Talk to the coworker, let him know you saw him take the candy, joke about how the company has lots of money so a few pieces of candy won't hurt anything; c) Tell your supervisor and let her handle the situation, but request they keep your name confidential when dealing with your coworker.” Player 4 chooses answer C. This is the correct answer. Due to the correct answer, Player 4 earns a sand dollar token 130 and places the sand dollar token 130 in the player piece 128. Player 4 places the selected interview card 144 in a used card deck or at the bottom of the interview card 144 deck. Player 4's turn is now over.

Since all players have made a first move, it is now Player 1's turn again. Player 1 rolls their dice 136 and rolls the number one. Player 1 moves the appropriate player piece 128 one space (e.g., one position marker 106) from Player 1's previous position along the path 104 and lands on a first symbol 114 (e.g., an anchor symbol) corresponding to the issue cards 142. Player 1 therefore takes the top card from the issue card 142 deck. The top card in the issue card 142 deck is a meal card including an illustration of a treasure chest (e.g., a lunch box) on it. Player 1 must therefore pack a healthy lunch or snack in the treasure chest (e.g., the container 138) on the game board. Player 1 starts the one minute timer (e.g., by flipping over the hourglass) and chooses from seven laminated food cards 146 in Player 1's player piece 128 to pack a healthy lunch. When the timer runs out, the player to the left of Player 1 (e.g., Player 4) can evaluate the packed lunch to determine if Player 1 has packed a healthy lunch. A healthy lunch must include water, fruits and/or vegetables, and a protein option. Player 1 has packed a can of soda, a candy bar and an apple. Player 1 therefore did not pack a healthy lunch and does not earn a sand dollar token 130. Player 1 places the selected meal card in a used card deck or at the bottom of the issue card 142 deck. Player 1's turn is now over.

Player 2 rolls their dice 136 and rolls the number five. Player 2 moves the appropriate player piece 128 five spaces (e.g., five position markers 106) from Player 2's previous position along the path 104 and lands on a token symbol 120 (e.g., a sand dollar symbol). In particular, rather than moving along the shortcut 122, Player 2 decided to move along the major path 104 to bypass the shortcut 122 and land on the token symbol 120. Player 2 earns a token 130 without having to answer a question or perform a task and, therefore, places a token 130 into the player piece 128. Player 2's turn is now over.

Player 3 rolls their dice 136 and rolls the number three. Player 3 moves the appropriate player piece 128 three spaces (e.g., three position markers 106) from the starting point 108 (since Player 3 previously incurred a penalty and moved back to the starting point 108) and lands on a first symbol 114 (e.g., an anchor symbol) corresponding to the issue cards 142. Player 3 therefore takes the top card from the issue card 142 deck. The top card in the issue card 142 deck is a merman/mermaid card including an illustration of a mermaid on it. Player 3 places the mermaid figure 134 in the player piece 128 to indicate that Player 3 has lost a turn and will not be able to roll the dice 136 to move in the next round. In some embodiments, the merman/mermaid card can include a question or an example of an inappropriate work relationship. If the merman/mermaid card includes a question, Player 3 has a chance of earning a token 130 if the question is answered correctly. After Player 3 has missed the turn in the next round, Player 3 can take the mermaid figure 134 (e.g., an icon suggesting an inappropriate work relationship) out of the player piece 128 and can resume playing.

After moving along the path 104 and collecting eight tokens 130 (e.g., an amount of tokens 130 below the amount necessary to win the game), Player 1 moves along the path 104 in the direction of the finish point 110. Player 1's last position along the path 104 is two position markers 106 away from the finish point 110. Player 1 rolls their dice 136 and rolls the number six. Since Player 1 does not have a sufficient number of tokens 130 to win the game and enter the finish point 110, Player 1 moves the appropriate player piece 128 two spaces in the direction of the finish point 110 and automatically moves back to the starting point 108 to move the remaining four spaces along the path 104, landing on a first symbol 114. Player 1 must therefore continue to play the game to earn a sufficient number of tokens 130 to move into the finish point 110. To continue playing the game, Player 1 can initially move backwards along the path 104 away from the finish point 110 and, in subsequent turns, can move in any direction along the path 104 (e.g., forward and backwards) along the path 104 to collect additional tokens 130. Player 1 can continue to collect tokens 130 upon landing on the token symbol 120 and/or correctly answering interview or issue questions. Player 1 therefore continues to collect tokens 130 until the requisite number of tokens 130 has been collected for entering the finish point 110.

After moving along the path 104 and collecting ten tokens 130 (e.g., the amount of tokens 130 necessary to win the game), Player 2 moves along the path 104 in the direction of the finish point 110. Player 2's last position along the path 104 is three position markers 106 away from the finish point 110. Player 2 rolls their dice 136 and rolls the number five. Player 2 moves the appropriate player piece 128 three spaces (e.g., three position markers 106) from Player 2's previous position along the path 104 and lands on the finish point 110. Player 2 has therefore won the game. The game can be considered concluded or the remaining players can continue playing to determine who will be second, third and fourth.

Another Example of Several Turns of Game Played with 4 Players.

All players can place their player pieces 128 near the word START at the starting point 108. All of the laminated food cards 146 can be stored in the container 138 (e.g., a treasure chest) until the use of the food cards 146 is necessitated by a player. Each player can roll their respective dice 136. The player with the highest number on their dice 136 can go first. The player to the right of the player to go first can be second, and so forth.

Player 1 rolls their dice 136 and rolls the number four. Player 1 moves the appropriate player piece 128 four spaces (e.g., four position markers 106) from the starting point 108 and lands on a first symbol 114 (e.g., an anchor symbol) corresponding to the issue cards 142. Player 1 therefore takes the top card from the issue card 142 deck. Player 1 reads the selected issue card 142 out loud. The issue card 142 reads: “A coworker has been consistently rude to you and you have no idea why. Today you noticed him talking with another coworker across the room, he pointed at you and they both laughed so you: a) Ignore then and focus on your work; b) Feel sad he is so mean to you and start crying; c) Stop working and go tell your supervisor; d) Talk to your supervisor after work and let her know how your coworker is acting towards you.” Player 1 chooses answer C. This is not the correct answer (the correct answer is A). Player 1 therefore does not earn a sand dollar token 130 and remains at the same position marker 106 on which Player 1 had landed. Player 1 places the selected issue card 142 in a used card deck or at the bottom of the issue card 142 deck. Player 1's turn is now over.

Player 2 rolls their dice 136 and rolls the number two. Player 2 moves the appropriate player piece 128 two spaces (e.g., two position markers 106) from the starting point 108 and lands on a second symbol 116 (e.g., a hook symbol) corresponding to the interview cards 144. Player 2 therefore takes the top card from the interview card 144 deck. Player 2 reads the selected interview card 144 out loud. The interview card 144 reads: “Why do you want to work for this company? a) I need the money, I am saving for a car; b) Your company is known for making great products that help people and I want to be part of that business model; c) I can save gas money since it is close to my house; d) Working here will allow me to use my current skills and develop new ones; e) This company is one of the better places to work in this town.” Player 2 chooses answer B. This is the correct answer (while answer D is also an acceptable answer). Due to the correct answer, Player 2 earns a sand dollar token 130 and places the sand dollar token 130 in the player piece 128. Player 2 places the selected interview card 144 in a used card deck or at the bottom of the interview card 144 deck. Player 2's turn is now over.

Player 3 rolls their dice 136 and rolls the number six. Player 3 moves the appropriate player piece 128 six spaces (e.g., six position markers 106) from the starting point 108, chooses the shortcut 122 path, and lands on the penalty position 124. Player 3 rolls the dice 136 again to determine if a penalty will be incurred, requiring Player 3 to move back to the starting point 108. Player 3 rolls the number two. Since Player 3 rolled an even number, Player 3 incurs a penalty and must move the player piece 128 back to the starting point 108. If Player 3 had rolled an odd number, Player 3 could have stayed in the penalty position 124 without incurring a penalty. Player 3's turn is now over.

Player 4 rolls their dice 136 and rolls the number five. Player 4 moves the appropriate player piece 128 five spaces (e.g., five position markers 106) from the starting point 108 and lands on a second symbol 116 (e.g., a hook symbol) corresponding to the interview cards 144. Player 4 therefore takes the top card from the interview card 144 deck. Player 4 reads the selected interview card 144 out loud. The interview card 144 reads: “If you noticed a coworker open a package of candy, take several pieces, then put the open bag back on the self and go back to work you would: a) Ignore the issue, it is none of your business; b) Talk to the coworker, let him know you saw him take the candy, joke about how the company has lots of money so a few pieces of candy won't hurt anything; c) Tell your supervisor and let her handle the situation, but request they keep your name confidential when dealing with your coworker.” Player 4 chooses answer C. This is the correct answer. Due to the correct answer, Player 4 earns a sand dollar token 130 and places the sand dollar token 130 in the player piece 128. Player 4 places the selected interview card 144 in a used card deck or at the bottom of the interview card 144 deck. Player 4's turn is now over.

Since all players have made a first move, it is now Player 1's turn again. Player 1 rolls their dice 136 and rolls the number one. Player 1 moves the appropriate player piece 128 one space (e.g., one position marker 106) from Player 1's previous position along the path 104 and lands on a first symbol 114 (e.g., an anchor symbol) corresponding to the issue cards 142. Player 1 therefore takes the top card from the issue card 142 deck. The top card in the issue card 142 deck is a meal card including an illustration of a treasure chest (e.g., a lunch box) on it. Player 1 must therefore pack a healthy lunch or snack in the treasure chest (e.g., the container 138) on the game board. Player 1 starts the one minute timer (e.g., by flipping over the hourglass) and selects the desired food cards 146 from the container 138 to pack a healthy lunch. In particular, Player 1 is able to choose the desired food cards 146 from the entire deck of food cards 146 to create a meal Player 1. When the timer runs out, the player to the left of Player 1 (e.g., Player 4) can evaluate the packed lunch to determine if Player 1 has packed a healthy lunch. A healthy lunch must include water, fruits and/or vegetables, and a protein option. Player 1 has packed a can of soda, a candy bar and an apple. Player 1 therefore did not pack a healthy lunch and does not earn a sand dollar token 130. Player 1 places the selected meal cards in a used card deck or at the bottom of the issue card 142 deck, and returns the food cards 146 back to the container 138. Player 1's turn is now over.

Player 2 rolls their dice 136 and rolls the number four. Player 2 moves the appropriate player piece 128 four spaces (e.g., four position markers 106) from Player 2's previous position along the path 104 and lands on a first symbol 114 (e.g., an anchor symbol) corresponding to the issue cards 142. Player 2 therefore takes the top card from the issue card 142 deck. The top card in the issue card 142 deck is a merman/mermaid card including an illustration of a mermaid on it. Player 2 places the mermaid figure 134 in the player piece 128 to indicate that Player 2 has lost a turn and will not be able to roll the dice 136 to move in the next round. After Player 2 has missed the turn in the next round, Player 2 can take the mermaid figure 134 (e.g., an icon suggesting an inappropriate work relationship) out of the player piece 128 and can resume playing.

Player 3 rolls their dice 136 and rolls the number two. Player 3 moves the appropriate player piece 128 two spaces (e.g., two position markers 106) from the starting point 108 (since Player 3 previously incurred a penalty and moved back to the starting point 108) and lands on a second symbol 116 (e.g., a hook symbol) corresponding to the interview cards 144. Player 3 therefore takes the top card from the interview card 144 deck. The interview card 144 indicates that Player 3 must respond to a video mock interview question, e.g., video mock interview question “D” of video questions numbered A-Z. The video mock interview question can be played via an electronic device, such as an iPAD®, a laptop, a projector, a SMARTBOARD™, or the like. The video mock interview question includes a video of a professionally dressed woman sitting at a desk and asking Player 3 the following question: “Tell me one of your strengths and one weakness.” Player 3 responds as follows: “I am always on time, but would like to become better organized.” The group of players determines by a consensus whether the response to the question by Player 3 is correct or proper. If the group decides that Player 3 correctly answered the mock interview question, Player 3 earns a token 130 and places the token 130 in the player piece 128. Player 3 places the selected interview card 144 in the used card deck or at the bottom of the interview card 144 deck. Player 3's turn is now over.

The game continues in the manner. The players have now moved along to various points along the path 104 with some players close to the finish point 110. Player 2 is on a position marker 106 including a second symbol 116 (e.g., a hook symbol) immediately adjacent to the finish point 110. However, Player 2 has only earned fourteen tokens 130 and is required to collect fifteen tokens 130 to move to the finish point 110 and win the game. Player 2 therefore rolls the dice 136 to continue player and rolls the number four. Player 2 moves the appropriate player piece 128 four spaces (e.g., four position markers 106) from Player 2's previous position backwards along the path 104 (away from the finish point 110) and lands on a token symbol 120. Player 2 therefore earns a free token 130, resulting in the requisite fifteen tokens for winning the game.

The remaining players make their move along the path 102. On Player 2's subsequent turn, Player 2 rolls the dice 136 and rolls the number five. Player 2 moves the appropriate player piece 128 five spaces (e.g., five position markers 106) from Player 2's previous position in the direction of the finish point 110 and lands on the finish point 110. Player 2 has therefore won the game and became “Captain of her own Destiny”. The game can be considered concluded or the remaining players can continue playing to determine who will be second, third and fourth.

It should be understood the Examples of this document are provided for illustrative purposes only and alternative methods of playing the board game of the present disclosure are envisioned.

1. A board game, comprising:
a board,
a plurality of position markers disposed on the board, the position markers creating a path leading from a starting point to a finish point, and
a plurality of cards,
wherein the plurality of cards include at least one of issue questions or interview questions to be answered by a player.

2. The board game of claim 1, wherein the interview questions are employment interview questions.

3. The board game of claim 1, comprising symbols disposed on each of the position markers, wherein the symbols are at least one of a first symbol, a second symbol, or a token symbol.

4. The board game of claim 3, wherein the first symbol corresponds to issue cards of the plurality of cards, the issue cards including the issue questions relating to problem solving.

5. The board game of claim 3, wherein the second symbol corresponds to interview cards of the plurality of cards, the interview cards including the interview questions relating to interviews.

6. The board game of claim 4, wherein the issue cards include inappropriate work relationship cards.

7. The board game of claim 3, wherein the token symbol corresponds to collection of a token by the player.

8. The board game of claim 1, comprising player pieces for moving along the path.

9. The board game of claim 1, comprising tokens, wherein the tokens are collected by the player upon correctly answering questions of the plurality of cards.

10. The board game of claim 1, wherein a player must collect a predetermined number of tokens to move into the finish point.

11. The board game of claim 1, comprising a shortcut path formed by some of the position markers, the shortcut path decreasing the steps along the path between the starting point and the finish point.

12. The board game of claim 1, comprising a plurality of food cards, a portion of the plurality of food cards being distributed to the player.

13. The board game of claim 1, wherein some questions are provided in an audio or video format.

14. A method of playing a game, comprising:
providing a board game, the board game including (i) a board, (ii) a plurality of position markers disposed on the board, the position markers creating a path leading from a starting point to a finish point, and (iii) a plurality of cards, the plurality of cards including at least one of an issue question or an interview question,
selecting at least one of an issue card or an interview card from the plurality of cards, the issue card including the issue question and the interview card including the interview question, and
answering at least one of the issue question or the interview question.

15. The method of claim 14, comprising selecting the issue card from the plurality of cards, the issue card including a question relating to problem solving.

16. A board game, comprising:
a board,
a plurality of position markers disposed on the board, the position markers creating a path leading from a starting point to a finish point,
a plurality of cards,
wherein some of the plurality of cards include an interview question to be answered by a player.

17. The board game of claim 16, comprising a plurality of food cards, a portion of the plurality of food cards being distributed to the player.

18. The board game of claim 16, wherein some of the plurality of cards include an issue question to be answered by the player.

19. (canceled)

20. (canceled)

21. The board game of claim 16, wherein the interview question is an employment interview question.

22. The board game of claim 16, comprising a shortcut path formed by some of the position markers, the shortcut path decreasing the steps along the path between the starting point and the finish point.
